(19) United States
(12) Patent Application Publication
(10) Pub. No.: US 2001/0025778 A1
(43) Pub. Date: Oct. 4, 2001

(54) Switch for game controller

(76) Inventor: Atsushi Ono, Tokyo (JP)

Correspondence Address: McGuire Woods,, 1750 Tysons Boulevard, Suite 1800, Tysons Corner, McLean, VA, 22102-3915, US

(21) Appl. No.: 09/817,373

(22) Filed: Mar. 27, 2001

(30) Foreign Application Priority Data
Mar. 31, 2000 (JP) P. 2000-098693

(51) Int. Cl. H01H 1/10

(52) U.S. Cl. 200/512; 200/1 B

(57) ABSTRACT

In a switch for a game controller, a click rubber is provided in a casing mounted on a base plate and adapted to be deformed and displaced by push-down operation of a button. Contacts are adapted to be operated by the deformation and displacement of the click rubber to control an output of a signal. An conductive body is provided at a lower end part of a body of the click rubber, and the base plate is provided with an upper contact and a lower contact which are vertically apart from each other and opposed to the conductive body. The lower contact is covered with a first resist formed of an inductive body, the upper contact is mounted on a second resist and arranged at a position higher than height of the first resist covering the lower contact.

### BACKGROUND OF THE INVENTION

The present invention relates to a switch for a game controller, and more particularly to the switch for the game controller which is constructed in such a manner that an “on” and “off” signal is outputted with operation of a button, and by strongly pushing down the button, an analog signal corresponding to the push-down operation of the button is outputted.

A related switch for a game controller of this type will be explained referring to FIG. 6. The switch 1 for the game controller consists of a base plate 4 on which a pair of contacts 2 and 3 are fixed, a click rubber 5 provided on the base plate 4 which will be described later, a button 7 placed on the click rubber 5, and a casing 8 which is mounted on the base plate 4 covering the click rubber 5 and the button 7. The casing 8 is substantially in an inverted shape of a bottomed cylinder, and provided with an opening 8a at its upper end part. The click rubber 5 is composed of a cylindrical body 5a in a substantially cylindrical shape, leg portions 5b extended from an outer peripheral part of a lower end of the cylindrical body Sa diagonally downward and formed of elastic material, and foot portions 5c arranged at lower end parts of the leg portions 5b. An conductive body 6 is fixed to the lower end part of the cylindrical body 5a. Moreover, the foot portions 5c are mounted on the base plate 4 and at the same time, retained by a lower end part of the casing 8. The button 7 consists of an upper small diameter portion 7a in a cylindrical shape and a lower large diameter portion 7b in a cylindrical shape. The upper small diameter portion 7a is arranged so as to pass through the opening 8a formed in the casing 8 and project upward from the casing 8, while the lower large diameter portion 7b is provided underneath the upper end part of the casing 8 and biased in an upward direction by means of the click rubber 5.

When the button 7 is pushed downward, the leg portions 5b of the click rubber 5 are deformed with the pushing motion of the button 7, and the click rubber 5 is displaced downward. When the click rubber 5 has been displaced by a determined distance, the leg portions 5b are greatly deformed instantaneously and the click rubber 5 is displaced to the lowermost position, whereby the conductive body 6 provided on the cylindrical body 5a is brought into contact with the contacts 2 and 3 and allows the contacts 2 and 3 to be conducted. Moreover, when the leg portions 5b are greatly deformed instantaneously, an operator of the button 7 can feel a touch of a click, and the operator can confirm the conduction between the contacts 2 and 3 from the touch of the click.

In the related switch for the game controller as described above, when the button is pushed downward, the leg portions of the click rubber are deformed by the push motion of the button, and the click rubber is displaced downward. Then, when the crick rubber is displaced to the lowermost position, the conductive body fixed to the lower end part of the click rubber comes in contact with a pair of the contacts on the base plate to allow the contacts to be conducted. However, an output corresponding to the button operation in the switch for the game controller is limited to an output of a digital signal by “on” and “off” operation, and therefore, has been insufficient in function to act as the switch for the game controller.

### SUMMARY OF THE INVENTION

Therefore, in the switch for the game controller employing the button, there has been a technical demand that both the digital signal of the “on” and “off” switch by the button operation and an analog signal corresponding to push-down operation of the button can be outputted, and at the same time, operability of the button may be enhanced. It is an object of the invention to solve this problem.

In order to achieve the above object, according to the invention, there is provided a switch for a game controller, comprising:

a base plate;

a first lower contact disposed on the base plate;

a first resist for covering the first lower contact, the first resist made of an inductive material;

a second lower contact disposed on the base plate;

a second resist for covering the second lower contact, the second resist made of an inductive material;

an upper contact formed on the second resist so as to be placed higher than a top face of the first resist;

a click rubber disposed above the upper contact;

a conductive body provided on a bottom portion of the click rubber so as to face the upper contact and the first resist; and

a button for deforming the click rubber such that the conductive body is brought into contact with the upper contact when a predetermined pressing force is applied, and such that the conductive body is further brought into contact with the first resist when a pressing force larger than the predetermined pressing force is applied.

Here, an output signal is established when the conductive body is brought into contact with the upper contact, and an analog output signal in accordance with the pressing force is generated when the conductive body is brought into contact with the first resist.

According to the invention, there is also provided a switch for a game controller, comprising:

a base plate;

a lower contact disposed on the base plate;

a first resist for covering the lower contact, the first resist made of an inductive material;

a second resist disposed on the base plate, the resist made of an inductive material;

an upper contact formed on the second resist such that a top face thereof is flush with a top face of the second resist;

a click rubber disposed above the upper contact;

a conductive body provided on a bottom portion of the click rubber so as to face the upper contact and the first resist; and

a button for deforming the click rubber such that the conductive body is brought into contact with the upper contact and the first resist when a predetermined pressing force is applied.

Here, an output signal is established when the conductive body is brought into contact with the upper contact and the first resist, and an analog output signal in accordance with the pressing force is generated when the conductive body is pressed against by a pressing force larger than the predetermined pressing force.

In the above configurations, both the “on” and “off” signal as the digital signal and the analog signal can be outputted, and in addition, the digital signal and the analog signal can be identified by the load of the touch which the operator feels through the button operation. Accordingly, extremely enhanced operability as the switch for the game controller can be achieved.

### BRIEF DESCRIPTION OF THE DRAWINGS

In the accompanying drawings:

FIG. 1 is a vertical section view showing a switch for a game controller according to a first embodiment of the invention;

FIG. 2 is a plan view of contacts in FIG. 1;

FIG. 3 shows an equivalent circuit of the switch in FIG. 1;

FIG. 4 is a graph showing relations among a displaced amount of a button of the switch in FIG. 1, a load of a touch which a button operator feels, and an output;

FIG. 5 is a vertical section view showing a switch for the game controller according to a second embodiment of the invention; and

FIG. 6 is a vertical section view of a related switch for a game controller.

### DETAILED DESCRIPTION OF THE PREFERRED EMBODIMENTS

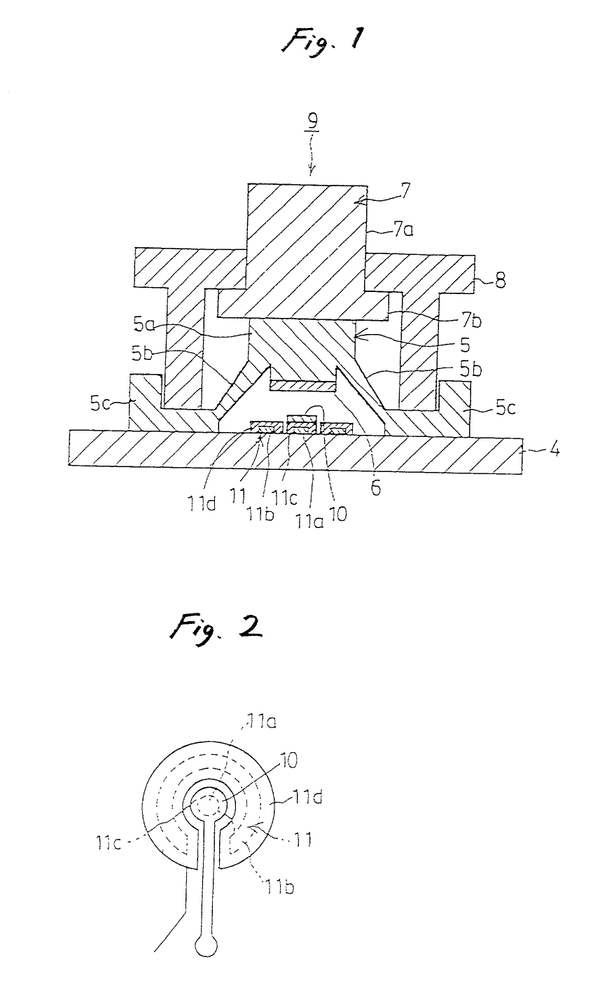

Now, preferred embodiments of the invention will be described in detail referring to the accompanying drawings. For convenience of explanation, those components identical to those in the related art will be represented by the same reference numerals, and their explanation will be omitted. In FIG. 1, numeral 9 represents a switch for a game controller according to a first embodiment of the invention. The switch 9 has an upper contact 10 and a lower contact 11 which are provided on the base plate 4 vertically apart from each other and opposed to the conductive body 6 provided on the click rubber 5.

As shown in FIG. 2, the lower contact 11 is composed of a circular contact 11a and an annular contact 11b in a C shape which is connected to the circular contact 11a and provided around the circular contact 11a apart therefrom. The circular contact 11a and the annular contact 11b are respectively covered with resists 11c and 11d made of inductive bodies. The upper contact 10 is mounted on the resist 11c which covers the circular contact 11a. The upper contact 10 is arranged at a position higher than the resist 11d which covers the annular contact 11b.

In FIG. 1, when the button 7 is pushed downward, the leg portions 5b of the click rubber 5 are deformed with the pushing motion of the button 7 and the click rubber 5 is displaced downward. When the click rubber 5 has been displaced by a determined distance, the leg portions 5b are greatly deformed instantaneously and the click rubber 5 is rapidly displaced downward, whereby the conductive body 6 fixed to the lower end part of the cylindrical body 5a of the click rubber 5 comes in contact with the upper contact 10 to output an “on” signal which is the so-called digital signal. Further pushing down the button 7, an upper end part of the upper contact 10 is displaced downward, and at the same time, the conductive body 6 comes in contact with the resist 11d covering the annular contact 11b. Thus, the conductive body 6, the resist 11d and the annular contact 11b serve as a condenser, and a signal output by the function as the condenser is generated. The conductive body 6, the resist 11c and the circular contact 11a also serve as a condenser in the same manner.

Furthermore, when the button 7 is strongly pushed down, deformation of the resists 11d and 11c becomes larger, and an analog signal is outputted by the function as the condenser in correspondence with the push-down operation of the button 7. Capacity of the function as the condenser is increased according to amounts of deformation of the resists 11d and 11c. An output pulse signal becomes larger in width of the pulse with the increase in the capacity of the function as the condenser, and the output is thus transmitted to a game machine (not shown).

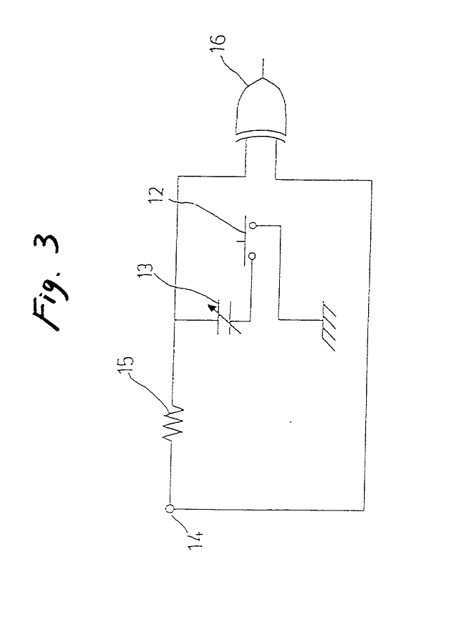

FIG. 3 shows an equivalent circuit of the switch 9 in which the upper contact 10 and the conductive body 6 correspond to a switch 12, while the contact 1, the resists 11c and 11d, and the conductive body 6 correspond to a condenser 13 of variable capacity type. Capacity of the condenser 13 is increased according to the amount of deformation of the resists 11c and 11d. Moreover, the switch 12 and the condenser 13 are connected in series. An end at a side of the switch 12 is grounded and the other end at a side of the condenser 13 is connected to a line which exists between a resistor 15 connected to a clock terminal 14 and one of input terminals of an exclusive OR gate 16 (hereinafter, simply referred to as EX-OR gate). The other input terminal of the EX-OR gate 16 is connected to the clock terminal 14.

When the switch 12 is closed, an “on” signal of the switch 12 is transmitted to the game machine (not shown) as the output of the digital signal from the switch 9 by way of the EX-OR gate 16. When the button 7 is further pushed down and the resists 11c and 11d are deformed, the capacity of the condenser 13 is changed, and a signal corresponding to the change, that is, the signal in which the pulse width of the pulse signal is changed is transmitted to the EX-OR gate 16. Then, logical operation is conducted by the EX-OR gate 16, and the output is transmitted to the game machine as the output of the analog signal from the switch 9.

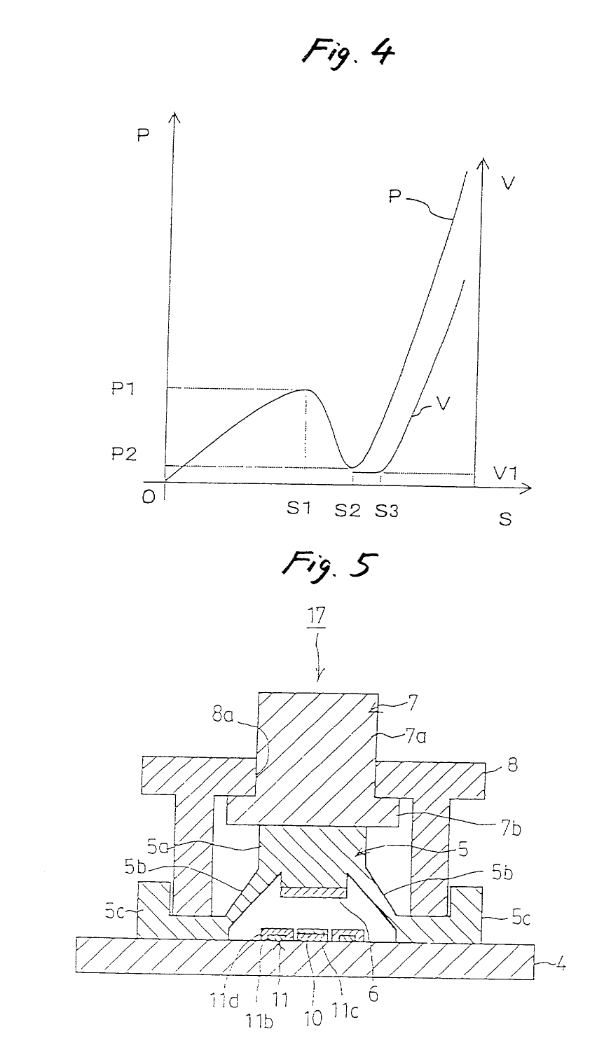

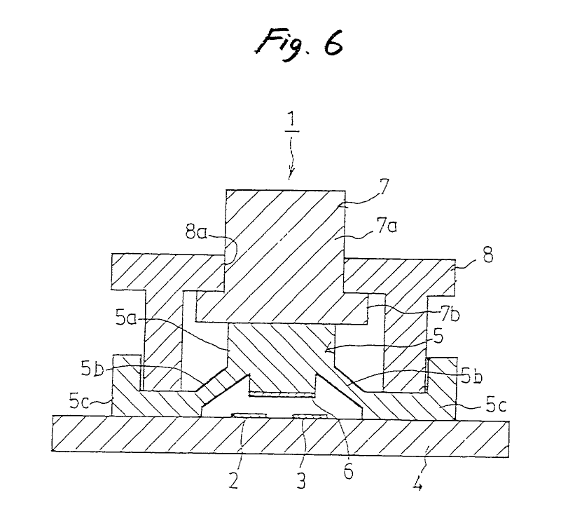

FIG. 4 is a graph showing relations among a stroke S of the button 7, a load P of the touch which the operator of the button 7 feels, and an output V of the switch 9. When the stroke S varies from 0 to S1, the load of the touch P also varies from 0 to P1 substantially in proportion to the stroke S. When the stroke S has arrived at S1, the load of the touch P is rapidly decreased from P1, and when the stroke S has arrived at S2, the load of the touch P is decreased to P2. This phenomenon is because the leg portions 5b are greatly deformed. Further, when the stroke S is increased to be more than S2, the load of the touch P is increased substantially in proportion to the stroke S. When the stroke S has arrived at S2, in other words, when the conductive body 6 has come in contact with the upper contact 10, an output V1 is generated as the output V of the switch 9. In short, this is the “on” signal as the digital signal output. The output V is maintained at V1 while the stroke S varies from S2 to S3. When the stroke S has arrived at S3, in other words, when the conductive body 6 has come in contact with the resist 11d, the output V begins to increase from V1 substantially in proportion to the increase in the load of the touch P, and the so-called analog output can be generated. With this structure, the operator of the button 7 can identify the digital signal and the analog signal by the load of the touch P when outputting them.

FIG. 5 shows a switch for a game controller 17 according to a second embodiment of the invention. In the switch 17, an upper end of the contact 10 is arranged so as to be at the same height as an upper end of the resist 11d covering the annular contact 11b, and the circular contact (the contact 11a in FIG. 1) of the switch 9 is omitted. The switch 17 is the same as the switch 9 in respect of the other structure. In the switch 17, the conductive body 6 comes in contact with the upper contact 10 and at the same time, comes in contact with the resist 11d of the annular contact 11b. Accordingly, when the “on” signal as the digital signal is outputted, the analog signal starts to generated at the same instant. As described, this switch 17 and the switch 9 are different from each other with respect to the signals which are outputted by pushing down the button 7, and therefore, can be appropriately selected for use according to a type of the game.

Further, in both the switch 17 and the switch 9, the displacement in only one direction, that is, a direction of Z axis is outputted as the digital and analog signals, but displacements in directions of X axis and Y axis in addition to the Z axis can be also outputted as the digital and analog signals in the same manner. Thus, a so-called joystick function can be attained with a small sized button.

It is apparent that various modifications can be added to the invention unless they deviate from the spirit of the invention, and that the modifications are also included in the invention.

What is claimed is:

1. A switch for a game controller comprising:
a base plate;
a first lower contact disposed on the base plate;
a first resist for covering the first lower contact, the first resist made of an inductive material;
a second lower contact disposed on the base plate;
a second resist for covering the second lower contact, the second resist made of an inductive material;
an upper contact formed on the second resist so as to be placed higher than a top face of the first resist a click rubber disposed above the upper contact;
a conductive body provided on a bottom portion of the click rubber so as to face the upper contact and the first resist; and
a button for deforming the click rubber such that the conductive body is brought into contact with the upper contact when a predetermined pressing force is applied, and such that the conductive body is further brought into contact with the first resist when a pressing force larger than the predetermined pressing force is applied.

2. The switch as set forth in claim 1, wherein an output signal is established when the conductive body is brought into contact with the upper contact, and an analog output signal in accordance with the pressing force is generated when the conductive body is brought into contact with the first resist.

3. A switch for a game controller, comprising:
a base plate;
a lower contact disposed on the base plate;
a first resist for covering the lower contact, the first resist made of an inductive material;
a second resist disposed on the base plate, the resist made of an inductive material;
an upper contact formed on the second resist such that a top face thereof is flush with a top face of the second resist;
a click rubber disposed above the upper contact;
a conductive body provided on a bottom portion of the click rubber so as to face the upper contact and the first resist; and
a button for deforming the click rubber such that the conductive body is brought into contact with the upper contact and the first resist when a predetermined pressing force is applied.

4. The switch as set forth in claim 3, wherein an output signal is established when the conductive body is brought into contact with the upper contact and the first resist, and an analog output signal in accordance with the pressing force is generated when the conductive body is pressed against by a pressing force larger than the predetermined pressing force.
